(19) United States
(12) Patent Application Publication
(10) Pub. No.: US 2014/0366326 A1
(43) Pub. Date: Dec. 18, 2014

(54) ELASTICALLY DEFORMABLE RETAINING HOOK FOR COMPONENTS TO BE MATED TOGETHER AND METHOD OF ASSEMBLING

(71) Applicant: GM Global Technology Operations LLC, Detroit, MI (US)

(72) Inventors: Joel Colombo, Howell, MI (US); Jeffrey L. Konchan, Romeo, MI (US); Steven E. Morris, Fair Haven, MI (US); Steve J. Briggs, Harrison Township, MI (US)

(21) Appl. No.: 13/917,074

(22) Filed: Jun. 13, 2013

(51) Int. Cl. E05B 85/10; F16B 17/00

(52) U.S. Cl. CPC E05B 85/10; F16B 17/002
USPC 16/412; 29/446; 403/280

(57) ABSTRACT

An elastically deformable retaining hook for matable components includes a first component having a body portion extending from a first end to a second end. Also included is a second component extending from a first end to a second end. Further included is a slot disposed in the first end of the second component and defined by a first, second, third, and fourth slot wall. Yet further included is a hook portion disposed proximate the first end of the body portion. The hook portion includes a first segment extending angularly from the body portion. The hook portion also includes a second segment extending angularly from the first segment and configured to fittingly engage the slot of the second component, wherein the second segment is formed of an elastically deformable material and configured to elastically deform upon engagement with the first slot wall and the second slot wall.

### FIELD OF THE INVENTION

The invention relates to components to be mated together and, more particularly, to an elastically deformable retaining hook for such components, as well as a method of assembly of the components.

### BACKGROUND

Currently, components which are to be mated together in a manufacturing process are subject to positional variation based on the mating arrangements between the components. One common arrangement includes components mutually located with respect to each other by 2-way and/or 4-way male alignment features; typically undersized male structures which are received into corresponding oversized female alignment features such as apertures in the form of openings and/or slots. Alternatively, double-sided tape, adhesives or welding processes may be employed to mate parts. Irrespective of the precise mating arrangement, there is a clearance between at least a portion of the alignment features which is predetermined to match anticipated size and positional variation tolerances of the mating features as a result of manufacturing (or fabrication) variances. As a result, occurrence of significant positional variation between the mated components is possible, which may contribute to the presence of undesirably large and varying gaps and otherwise poor fit. The clearance between the aligning and attaching features may lead to relative motion between mated components, which may contribute to poor perceived quality. Additional undesirable effects may include squeaking and rattling of the mated components, for example.

### SUMMARY OF THE INVENTION

In one exemplary embodiment, an elastically deformable retaining hook for matable components includes a first component having a body portion extending from a first end to a second end. Also included is a second component extending from a first end to a second end. Further included is a slot disposed in the first end of the second component and defined by a first, second, third, and fourth slot wall. Yet further included is a hook portion disposed proximate the first end of the body portion. The hook portion includes a first segment extending angularly from the body portion. The hook portion also includes a second segment extending angularly from the first segment and configured to fittingly engage the slot of the second component, wherein the second segment is formed of an elastically deformable material and configured to elastically deform upon engagement with the first slot wall and the second slot wall.

In another exemplary embodiment, an automobile door handle assembly includes a handle insert having a body portion extending in a substantially longitudinal direction from a first end to a second end. Also included is a door handle extending in the substantially longitudinal direction from a first end to a second end. Further included is a slot disposed in the first end of the door handle and defined by at least one slot wall. Yet further included is a hook portion disposed proximate the first end of the handle insert, the hook portion comprising a retaining segment extending in the substantially longitudinal direction, wherein the retaining segment is configured to fittingly engage the slot of the door handle, wherein the retaining segment is formed of an elastically deformable material and configured to elastically deform upon engagement with the at least one slot wall.

In yet another exemplary embodiment, a method of assembling an automobile door handle is provided. The method includes positioning a handle insert into close proximity with a door handle. The method also includes engaging a retaining segment extending from a first end of the handle insert into a slot disposed in an end of the door handle. The method further includes elastically deforming the retaining segment upon engagement of the retaining segment with a first slot wall and a second slot wall.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a perspective view of a first component and a second component configured to be mated together;

FIG. 2 is a perspective view of the first component;

FIG. 3 is a perspective view of the second component;

FIG. 4 is a cross-sectional view of a hook portion of the first component engaged with a slot of the second component; and

FIG. 5 is a flow diagram illustrating a method of assembling an automobile door handle.

### DESCRIPTION OF THE EMBODIMENTS

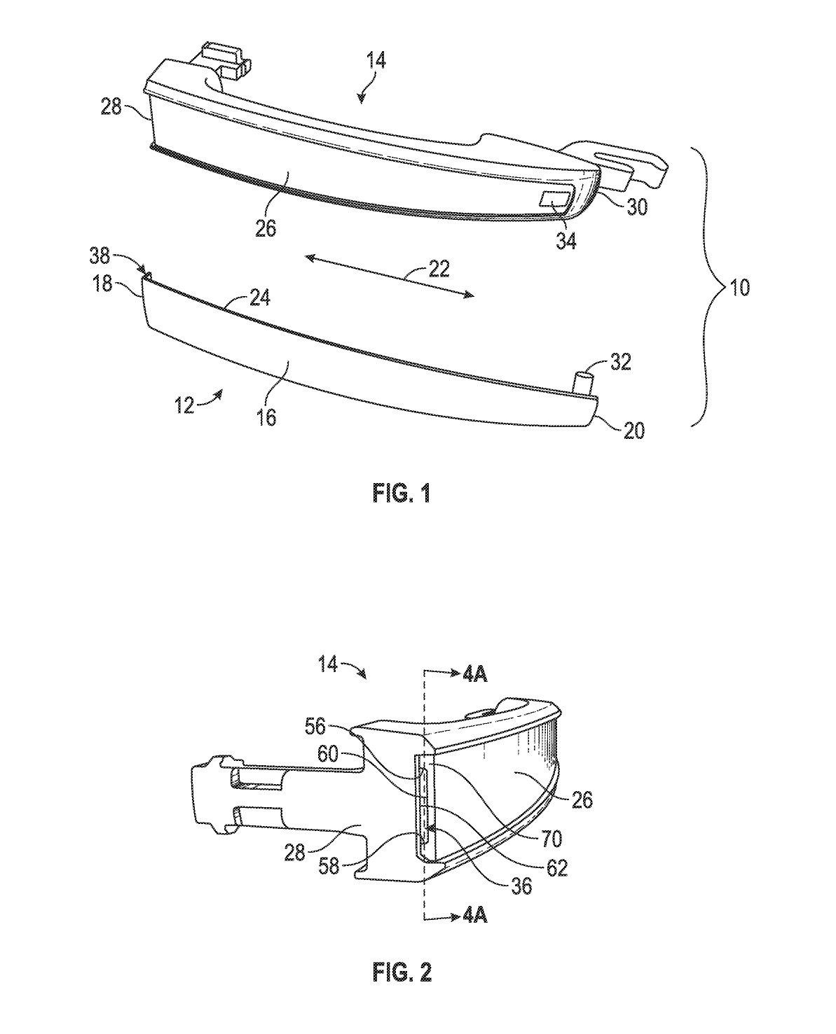

Referring to FIG. 1, a retaining assembly 10 is illustrated. The retaining assembly 10 comprises components configured to be engaged or mated with each other, such as a first component 12 and a second component 14. The retaining assembly 10 may be associated with numerous applications and industries, such as home appliance and aerospace applications, for example. In one embodiment, the retaining assembly 10 is employed in a vehicle, such as an automobile. In an automobile embodiment, the retaining assembly 10 may comprise a door handle assembly including a door handle and a handle insert. As will be appreciated from the description herein, embodiments of the retaining assembly 10 may be used in any application that benefits from a reduction or elimination of gaps that may result in vibration and noise or poor appearance.

The first component 12 includes a body portion 16 extending from a first end 18 to a second end 20 in a substantially longitudinal direction 22. It is to be appreciated that the geometry of the body portion 16 typically includes slight curvature that deviates from the substantially longitudinal direction 22. Irrespective of the precise degree of curvature, or lack thereof, a first engagement surface 24 is located along the body portion 16 and is configured to engage the second component 14 along a second engagement surface 26 of the second component 14. Similar to the first component 12, the second component 14 extends along the substantially longitudinal direction 22, but may include slight curvature, with the second component 14 extending between respective ends. Specifically, the second component 14 extends from a first end 28 to a second end 30. The first component 12 may include one or more auxiliary locating features 32 that assist with location and retention of the first component 12 relative to the second component 14. The auxiliary locating features 32 may engage one or more apertures 34 of the second component 14. The auxiliary locating features 32 may be formed of an elastically deformable material, with such materials being described in detail below. However, it is contemplated that location and retention of the first component 12 to the second component 14 may be facilitated with the embodiments described below, without the need for the auxiliary locating features 32.

Referring to FIG. 2, proximate the first end 28 of the second component 14 is a slot 36 formed therein. As will be described in detail herein, the slot 36 comprises a receiving feature that is configured to fittingly engage a retaining member of the first component 12. The second component 14 includes a first slot wall 56, a second slot wall 58, a third slot wall 60 and a fourth slot wall 62. In conjunction, the slot walls 56, 58, 60, 62 define the slot 36.

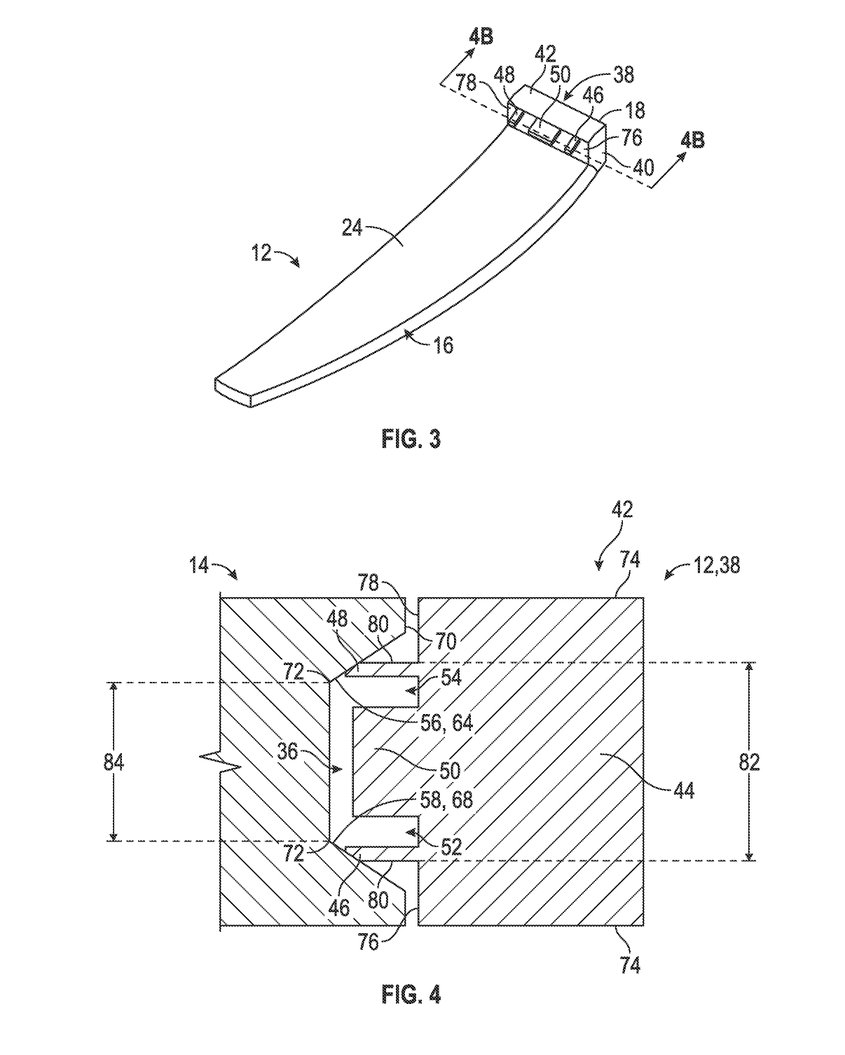

Referring now to FIG. 3, the first component 12 is shown to better illustrate the first engagement surface 24, as well as the retaining member referenced above. Specifically, a hook portion 38 is disposed proximate the first end 18 of the body portion 16 of the first component 12. The hook portion 38 includes a first segment 40 extending angularly away from the first engagement surface 24 of the body portion 16. In one embodiment, the first segment 40 is positioned at an angle of about 90° from the body portion 16 in a substantially orthogonal relationship. The first segment 40, and more generally the hook portion 38, may be operatively coupled to, or integrally formed with, the body portion 16 of the first component 12. The hook portion 38 also includes a second segment 42 extending angularly away from the first segment 40 of the hook portion 38. In one embodiment, the second segment 42 is positioned at an angle of about 90° from the first segment 40 in a substantially orthogonal relationship. The second segment 42 is configured to be inserted into the slot 36 and is formed of an elastically deformable material that facilitates precise alignment and fitted engagement of the first component 12 with the second component 14. In other embodiments, the entire hook portion 38 is formed of an elastically deformable material. In yet another embodiment, the entire first component 12 is formed of an elastically deformable material.

Any suitable elastically deformable material may be used for the second segment 42. The term “elastically deformable” refers to components, or portions of components, including component features, comprising materials having a generally elastic deformation characteristic, wherein the material is configured to undergo a resiliently reversible change in its shape, size, or both, in response to application of a force. The force causing the resiliently reversible or elastic deformation of the material may include a tensile, compressive, shear, bending or torsional force, or various combinations of these forces. The elastically deformable materials may exhibit linear elastic deformation, for example that described according to Hooke's law, or non-linear elastic deformation.

Numerous examples of materials that may at least partially form the components include various metals, polymers, ceramics, inorganic materials or glasses, or composites of any of the aforementioned materials, or any other combinations thereof. Many composite materials are envisioned, including various filled polymers, including glass, ceramic, metal and inorganic material filled polymers, particularly glass, metal, ceramic, inorganic or carbon fiber filled polymers. Any suitable filler morphology may be employed, including all shapes and sizes of particulates or fibers. More particularly any suitable type of fiber may be used, including continuous and discontinuous fibers, woven and unwoven cloths, felts or tows, or a combination thereof. Any suitable metal may be used, including various grades and alloys of steel, cast iron, aluminum, magnesium or titanium, or composites thereof, or any other combinations thereof. Polymers may include both thermoplastic polymers or thermoset polymers, or composites thereof, or any other combinations thereof, including a wide variety of co-polymers and polymer blends. In one embodiment, a preferred plastic material is one having elastic properties so as to deform elastically without fracture, as for example, a material comprising an acrylonitrile butadiene styrene (ABS) polymer, and more particularly a polycarbonate ABS polymer blend (PC/ABS), such as an ABS acrylic. The material may be in any form and formed or manufactured by any suitable process, including stamped or formed metal, composite or other sheets, forgings, extruded parts, pressed parts, castings, or molded parts and the like, to include the deformable features described herein. The material, or materials, may be selected to provide a predetermined elastic response characteristic of the second segment 42 of the hook portion 38. The predetermined elastic response characteristic may include, for example, a predetermined elastic modulus.

Referring now to FIG. 4, a cross-sectional view, taken along lines 4A-4A and 4B-4B of FIGS. 2 and 3, illustrates engagement of the second segment 42 of the hook portion 38 with the second component 14, and more particularly insertion of the second segment 42 within the slot 36. The second segment 42 comprises a main portion 44, with a first tab 46, a second tab 48 and a third tab 50 extending therefrom. The first tab 46 and the second tab 48 are formed by a first recess 52 and a second recess 54. The first recess 52 is present between the first tab 46 and the third tab 50, while the second recess 54 is present between the second tab 48 and the third tab 50.

As shown, the first slot wall 56 includes a first tapered portion 64 and the second slot wall 58 includes a second tapered portion 68. The first tapered portion 64 and the second tapered portion 68 angle inwardly from an outer edge 70 of the second component 14 toward respective inner ends 72. In the illustrated embodiment, the entireties of the first slot wall 56 and the second slot wall 58 are tapered in an angular manner, however, it is to be appreciated that only a portion of the first slot wall 56 and/or the second slot wall 58 may be tapered in alternative embodiments.

In the illustrated embodiment, the first tab 46 and the second tab 48 are positioned inwardly from respective side surfaces 74 of the second segment 42, thereby exposing a first abutment surface 76 and a second abutment surface 78. Upon full insertion of the second segment 42 into the slot 36, the first abutment surface 76 and the second abutment surface 78 may engage the outer edge 70 of the second component 14. The outer surfaces 80 of the first tab 46 and the second tab 48 define a hook width 82. A slot width 84 is defined by the distance between the respective inner ends 72 of the first tapered portion 64 and the second tapered portion 68 of slot walls 56, 58. The hook width 82 is greater than the slot width 84, such that insertion of the second segment 42 into the slot 36 results in engagement of the first tab 46 and the second tab 48 with the first slot wall 56 and the second slot wall 58, respectively. Subsequent to initial engagement of the tabs and the slot walls, further insertion of the second segment 42 results in deformation of the first tab 46 and the second tab 48. As described in detail above, deformation may occur in various forms, including bending and compression, for example. In the illustrated embodiment, the first tab 46 and the second tab 48 are shown in a deformed condition. The tabs are shown to be deflected inwardly to ensure engagement between the second segment 42 and the slot walls, thereby resulting in a tight, fitted engagement between the first component 12 and the second component 14. In one embodiment, the hook portion 38 provides a “snap-fit” engagement with the slot 36.

The elastic deformation of the second segment 42 averages any positional errors of the first component 12 and the second component 14. In other words, gaps and/or misalignment that would otherwise be present due to positional errors associated with portions or segments of the first component 12 and the second component 14, particularly locating and retaining features, are reduced or eliminated. Specifically, the positional variance of the hook portion 38, including the first segment 40 and/or second segment 42, is accounted for by deformation of the first tab 46 and the second tab 48 being averaged in aggregate.

Elastic averaging provides elastic deformation of the interface(s) between mated components, wherein the average deformation provides a precise alignment, the manufacturing positional variance being minimized to Xₘᵢₙ, defined by Xₘᵢₙ=X/√N, wherein X is the manufacturing positional variance of the locating features of the mated components and N is the number of features inserted. To obtain elastic averaging, an elastically deformable component is configured to have at least one feature and its contact surface(s) that is over-constrained and provides an interference fit with a mating feature of another component and its contact surface(s). The over-constrained condition and interference fit resiliently reversibly (elastically) deforms at least one of the at least one feature or the mating feature, or both features. The resiliently reversible nature of these features of the components allows repeatable insertion and withdrawal of the components that facilitates their assembly and disassembly. Positional variance of the components may result in varying forces being applied over regions of the contact surfaces that are over-constrained and engaged during insertion of the component in an interference condition. It is to be appreciated that a single inserted component may be elastically averaged with respect to a length of the perimeter of the component. The principles of elastic averaging are described in detail in commonly owned, co-pending U.S. patent application Ser. No. 13/187,675, the disclosure of which is incorporated by reference herein in its entirety. The embodiments disclosed herein provide the ability to convert an existing component that is not compatible with the described elastic averaging principles to an assembly that does facilitate elastic averaging and the benefits associated therewith.

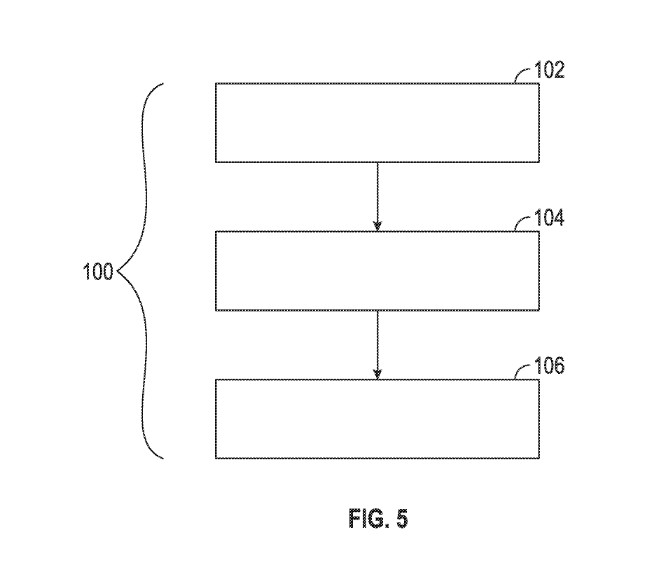

A method of assembling an automobile door handle 100 is also provided, as illustrated in FIG. 5, and with reference to FIGS. 1-4. The retaining assembly 10, and more specifically the elastically deformable nature of the hook portion 38, has been previously described and specific structural components need not be described in further detail. The method 100 includes positioning 102 a handle insert 12 into close proximity with a door handle 14. A retaining segment 38 extending from a first end 18 of the handle insert 12 is engaged 104 into the slot 36 disposed in an end of the door handle 14. The retaining segment 38 is elastically deformed 106 upon engagement 104 with the first slot wall 56 and the second slot wall 58.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. An elastically deformable retaining hook for matable components comprising:
a first component having a body portion extending from a first end to a second end;
a second component extending from a first end to a second end;
a slot disposed in the first end of the second component and defined by a first slot wall, a second slot wall, a third slot wall and a fourth slot wall; and
a hook portion disposed proximate the first end of the body portion, the hook portion comprising:
a first segment extending angularly from the body portion; and
a second segment extending angularly from the first segment and configured to fittingly engage the slot of the second component, wherein the second segment is formed of an elastically deformable material and configured to elastically deform upon engagement with the first slot wall and the second slot wall.

2. The elastically deformable retaining hook of claim 1, wherein the second segment comprises a first recess and a second recess to define a first tab and a second tab.

3. The elastically deformable retaining hook of claim 2, wherein the first tab engages the first slot wall and the second tab engages the second slot wall.

4. The elastically deformable retaining hook of claim 2, the first slot wall comprising a first tapered portion and the second slot wall comprising a second tapered portion, and wherein each of the first tapered portion and the second tapered portion angle inwardly from an outer edge of the second component toward respective inner ends.

5. The elastically deformable retaining hook of claim 4, further comprising a slot width defined by the distance between the respective inner ends, wherein the second segment comprises a hook width greater than the slot width.

6. The elastically deformable retaining hook of claim 1, wherein the hook portion is operatively coupled to the body portion.

7. The elastically deformable retaining hook of claim 1, wherein the hook portion is integrally formed with the body portion.

8. The elastically deformable retaining hook of claim 1 disposed in an automobile.

9. The elastically deformable retaining hook of claim 8, wherein the first component comprises a handle insert and the second component comprises a door handle.

10. An automobile door handle assembly comprising:
a handle insert having a body portion extending in a substantially longitudinal direction from a first end to a second end;
a door handle extending in the substantially longitudinal direction from a first end to a second end;
a slot disposed in the first end of the door handle and defined by at least one slot wall; and
a hook portion disposed proximate the first end of the handle insert, the hook portion comprising a retaining segment extending in the substantially longitudinal direction, wherein the retaining segment is configured to fittingly engage the slot of the door handle, wherein the retaining segment is formed of an elastically deformable material and configured to elastically deform upon engagement with the at least one slot wall.

11. The automobile door handle assembly of claim 10, wherein the hook portion comprises a first segment extending angularly from the body portion and a second segment extending angularly from the first segment, the second segment configured to fittingly engage within the slot.

12. The automobile door handle assembly of claim 10, the second segment comprising a first recess and a second recess to define a first tab and a second tab.

13. The automobile door handle assembly of claim 12, wherein the first tab and the second tab are each engaged with the at least one slot wall.

14. The automobile door handle assembly of claim 12, the at least one slot wall comprising a first slot wall having a first tapered portion and a second slot wall having a second tapered portion, each tapered portion angled inwardly from an outer edge of the door handle toward respective inner ends.

15. The automobile door handle assembly of claim 14, further comprising a slot width defined by the distance between the respective inner ends, wherein the second segment comprises a hook width greater than the slot width.

16. The automobile door handle assembly of claim 10, wherein the hook portion is operatively coupled to the body portion.

17. The automobile door handle assembly of claim 10, wherein the hook portion is integrally formed with the body portion.

18. A method of assembling an automobile door handle, the method comprising:
positioning a handle insert into close proximity with a door handle;
engaging a retaining segment extending from a first end of the handle insert into a slot disposed in an end of the door handle; and
elastically deforming the retaining segment upon engagement of the retaining segment with a first slot wall and a second slot wall.
